(19) United States
(12) Patent Application Publication
(10) Pub. No.: US 2016/0263595 A1
(43) Pub. Date: Sep. 15, 2016

(54) MICRO FOGGING DEVICE AND METHOD

(71) Applicant: Hong Kun Shin, Miryang-si (KR)

(72) Inventor: Hong Kun Shin, Miryang-si (KR)

(21) Appl. No.: 15/001,603

(22) Filed: Jan. 20, 2016

(30) Foreign Application Priority Data
Mar. 13, 2015 (KR) 10-2015-0035269
Sep. 17, 2015 (KR) 10-2015-0131879

(51) Int. Cl. B05B 7/04; B05B 1/02

(52) U.S. Cl. CPC B05B 7/0416; B05B 1/02

(57) ABSTRACT

The present invention relates to micro fogging device and method which can spray fog-like fine water particles by being applied for protected cultivation, such as green houses, or barns. The micro fogging device which can supply fog tinier than low pressure fog used generally includes: a low pressure fog for forming fog at low pressure; and a venture nozzle which is forcedly fit to a coupling pipe to a nozzle body of the low pressure fog to finely pulverize water particles supplied from the low pressure fog, thereby minimizing usage of water and compressed air and maximizing fog effectiveness.

### REFERENCE TO RELATED APPLICATIONS

This application claims the priority benefit of Korean Patent Application No. 10-201 5-01 31 879 filed on Sep. 17, 2015, and Korean Patent Application No. 10-2015-0035269 filed on Mar. 13, 2015, the entire contents of which are incorporated herein by reference.

### FIELD OF THE INVENTION

The present invention relates to a micro fogging device and method thereof, and more particularly, to a micro fogging device and method which can form fog tinier than low pressure fog used generally, thereby minimizing usage of water and compressed air, maximizing fog effectiveness and being applied for protected cultivation in greenhouses or for various use purposes, such as for watering, for humidification or for control of temperature, in industrial facilities.

### BACKGROUND OF THE INVENTION

Generally, a fogging device, which produces fine water particles like fog, is located in a green house or a barn in which a variety of vegetables, garden products, or farm animals are cultivated or raised to spray chemical liquid or adjust humidity and temperature thereinto.

A plastic fogging device used generally includes: a fixing body having coupling holes to which posts are coupled formed on one side or both sides thereof or in every direction thereof, a hose coupling pipe to which an insertion pipe and a hose are respectively fitted on the upper and lower sides thereof, and locking projections formed on both sides of the insertion pipe; a nozzle fixture having a I protrusion formed on the lower end periphery thereof in such a manner as to be coupled to the locking projections of the fixing body and handles protruding from both sides of the upper portion thereof; a nozzle adapted to be inserted into a nozzle insertion hole having a locking projection penetrating into the nozzle fixture; and a nipple screw-coupled to the nozzle fixture and having a fixing portion formed on the upper side thereof to pressurize the nozzle and a passage adapted to supply water from the insertion pipe to the nozzle.

The nozzle includes: a body having a locking step from which a protruding round rim protrudes to come into contact with the locking projection formed on the nozzle insertion hole; a nipple induction projection formed on the lower periphery of the body; a conical vortex space formed on the inner face of the body to supply water to a nozzle hole, which is formed on the upper end thereof, in the form of vortex; and one passage formed underneath the vortex space to guide the water to the vortex space from the outside of the body in the form of vortex. Further, the insertion hose of the fixing body and the nipple are coupled to be spaced apart from each other in their assembled state. According to the conventional plastic fogging device, when the nipple is disassembled and assembled to clean the nozzle, the nozzle is not rigidly pressurized upon the abrasion of the screw of the nipple, and even when the nozzle fixture and the nozzle are brought into close contact with each other, because the locking projection formed on the nozzle insertion hole at the inner face of the nozzle fixture and the protruding round rim formed on the locking step on the body of the nozzle are in point contact with each other, if a fine scar occurs on the protruding round rim, functionality of the nozzle may be deteriorated.

In order to remove the above-mentioned problems, the same inventor as the present invention proposed a plastic fogging device disclosed in Korean Utility Model Registration No. (Y1)20-0419612 (issued on Jun. 21, 2006). In Korean Utility Model Registration No. (Y1)20-0419612, a nozzle fixture and a nozzle get in surface contact with each other, and in the state where a nipple is coupled to the nozzle fixture, the lower end periphery of the nipple comes into contact with an insertion hose formed on the upper end periphery of a fixing body, so that the nozzle is always fixed under the same conditions. Further, the nozzle has a straight pipe portion formed underneath the vortex space in such a manner as to have the same height as a plurality of passages guiding water to the vortex space, thus enhancing water supply and fogging efficiency even under low pressure.

In the meantime, various technologies for generating fog have been proposed, and as a presentative example, there is a fog nozzle disclosed in Korean Patent Publication No. 10-2010-0035839 published on Apr. 7, 2010. The fog nozzle includes: a nozzle body having a jet orifice formed in one end thereof for spraying a fluid and a coupling hole formed in the inner peripheral surface of the other end thereof; a pressure pin having a head which is formed on an end thereof, has a guide hole and is inserted and joined into the inner peripheral surface of the other end of the nozzle body; an elastic body joined with the other end of the pressure pin; and a strainer whose one end has an inner peripheral surface to which the other end of the elastic body is inserted and an outer peripheral surface inserted and coupled to the coupling hole of the nozzle body, the strainer having inflow holes formed in the outer peripheral surface of the other end thereof for allowing inflow of the fluid.

As another example, Korean Patent No. 10-1232340 issued on Feb. 13, 2013 discloses an air fog generator. The air fog generator includes: a cylindrical first housing having a water supply port and a conical second housing having an air supply port and a nozzle port; the first housing and the second housing being screw-coupled to each other; a hydraulic adjustor provided in the inside of the housing to uniformly adjust pressure of water supplied and supply the adjusted water to the nozzle port; and a gas-liquid mixing unit provided in the inside of the housing to mix liquid discharged from the hydraulic adjustor with air flowing in through the air supply port and spray fine water drops through the nozzle port, wherein discharge pressure of the hydraulic adjustor is higher than air pressure of the gas-liquid mixing unit.

As a further example, Korean Patent Publication No. 10-2006-0128289 on Dec. 14, 2006 discloses an ultrafine water spray nozzle. In Korean Patent Publication No. 10-2006-0128289, a gas passage is mounted by a partition wall fit to the outer periphery of a liquid passage. The gas passage communicates with a spray port. The section of the gas passage formed at the spray port of the partition wall is formed in a deformed shape of a polygon, a long circle, or an oval, and the section of the outer peripheral surface of the gas passage is formed in a shape of a circle. The deformed outer surface of the partition wall comes into contact with the outer peripheral surface of the circular section at plural spots so that the gas passage formed at the spray port part is divided into plural gas passages in a peripheral direction. Alternatively, the section of the outer surface of the partition wall is formed in a shape of a circle, and the section of the outer peripheral surface of the spray port of the gas passage is formed in a deformed shape of a polygon, a long circle, or an oval. The outer peripheral surface of the partition wall comes into contact with the outer surface of the spray port of the gas passage at plural spots so that the gas passage formed at the spray port part is divided into plural gas passages in a peripheral direction. Therefore, the gas sprayed from the spray port of the divided gas passages is mixed with the liquid sprayed from the liquid passage and the mixture can be sprayed.

However, the conventional fog generators have several disadvantages in that there is a limit in providing micro-state fog because they form fog by pulverizing water (liquid) just once, and in that it is difficult to apply them to general farms at a low price because most of the fog generators using compressed air are an injector type which is complex in structure.

Meanwhile, the conventional fog products can make very tiny micro fog when a vortex body structure is applied to the structure that water is continuously supplied like the prior arts and high pressure is applied to the structure, but because the high pressure fog has a hole size of 0.1 mm to 0.3 mm, the high pressure fog is stopped by foreign matters floating in the water or calcium ions or iron ions dissolved in the water and is almost impossible to clean.

Furthermore, the low pressure micro fog is the method of finely pulverizing particles by continuously supplying water into a venturi space using twin-fluid. However, the low pressure micro fog also has a disadvantage in that it has to use a lot of air. So, capacity of a compressor must be increased.

Additionally, a conventional fog which pulverizes water by the micro unit using a flow rate of air flowing at high pressure when a flow direction of water is the same as a direction of the air also has several disadvantages in that capacity of the compressor must be increased because it consumes lots of compressed air, in that water must be drained off from the pipe because dripping water may be generated after use and it has a complicated structure and is spread at a high price because a dripping water preventing structure must be inserted into the fog.

### SUMMARY OF THE INVENTION

Accordingly, the present invention has been made in view of the above-mentioned problems occurring in the prior art, and it is an object of the present invention to provide micro fogging device and method which can first form water particles like fog using a low pressure fog and second form micro fog through a method of pulverizing the fog-like water particles supplied discontinuously using the venturi principle, thereby minimizing usage of water and compressed air, maximizing fog effectiveness, being capable of being produced and spreading at low price, and spraying fine water particles such as fog by being applied for protected cultivation in greenhouses or for various use purposes, such as for watering, for humidification or for control of temperature, in industrial facilities.

To accomplish the above-mentioned object, according to a first aspect of the present invention, there is provided a micro fogging device including: a low pressure fog for forming fog; and a venturi nozzle for finely pulverizing water particles discontinuously supplied from the low pressure fog, the venturi nozzle including a body, a venturi tube having an inflow hole through which compressed air flows in and an expansion part connected with the inflow hole by a throttle ring inside a spray pipe, a first coupler and spray pipe formed on the body on the same axial line in a straight form so that the venturi tube is formed, a second coupler formed at right angles to the first coupler, and a flow path communicating with a coupling pipe of the low pressure fog to be connected with the throttle ring, wherein the low pressure fog and the venturi nozzle are coupled in such a way that the coupling pipe protruding from a nozzle body of the low pressure fog is forcedly fit to the second coupler of the venturi nozzle.

According to the present invention, at least one of a fluid induction member or the nozzle body of the low pressure fog or the venturi nozzle is molded with synthetic resin mixed a silver nano material or an antimicrobial to eradicate germs.

To accomplish the above-mentioned object, according to a second aspect of the present invention, there is provided a micro fogging method including: a first step of first pulverizing water to form water particles through a low pressure fog; and a second step of second pulverizing the first pulverized water particles in a venturi nozzle by inducing the first pulverized water particles discontinuously provided from the low pressure fog to the venturi nozzle to which the venturi principle is applied so as to obtain micro water particles.

The micro fogging device and method according to the present invention can provide micro fog of high efficiency at low cost.

That is, the present invention can produce fog-like fine water particles by re-pulverizing fine water particles provided from the low pressure fog by the venturi nozzle, thereby minimizing usage of water and maximizing fog efficiency.

In a case that the present invention is applied to protected cultivation, such as greenhouses, the present invention can uniformly spray a medicinal fluid to the entire plants because finely spraying the medicinal fluid in the air.

Moreover, the present invention can provide easy humidification for farming or for industrial use because providing micro-state fog, and improve a flow of air to be favorable for reducing the indoor temperature when it is installed at a ventilation side of an industrial facility in the summer season.

Furthermore, the present invention can prevent inhabitation of germs in remaining water because the nozzle body or the fluid induction member of the low pressure fog or the venturi nozzle are made with the silver nano material, thereby solving the problems by germs when the present invention is used for humidification.

Additionally, the present invention can minimize supply of compressed air because the venturi nozzle pulverizes again the water particles first pulverized in the low pressure fog, thereby forming micro fog using a small-sized air compressor.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing an outward appearance of a micro fogging device according to a preferred embodiment of the present invention;

FIG. 2 is an exploded perspective view of the micro fogging device according to the preferred embodiment of the present invention;

FIG. 2a is a bottom prospective and sectional view of the nozzle body of the micro fogging device according to the preferred embodiment of the present invention;

FIG. 2b is a bottom plan view of the nozzle body of the micro fogging device according to the preferred embodiment of the present invention;

FIG. 3 is a sectional view of a low pressure fog applied to the present invention;

FIG. 4 is an enlarged bottom side perspective view of a venturi nozzle applicable to the present invention;

FIG. 5 is a sectional view of FIG. 4.

FIG. 6 is a sectional view showing an operational state of the micro fog provided by the present invention;

FIG. 7 is a perspective view showing an outward appearance of a micro fogging device for preventing a back flow of compressed air according to another preferred embodiment of the present invention;

FIG. 8 is an exploded perspective view showing a micro fogging device of FIG. 7;

FIG. 8a is a bottom prospective and sectional view of the discharge housing of the micro fogging device according to another embodiment of the present invention;

FIGS. 9 and 10 are sectional views showing a front face and a side face in a state where a back flow preventing device is assembled;

FIG. 11 is a sectional view showing an action of the micro fogging device by the back flow preventing device;

FIG. 12 is an enlarged cross-sectional plan view showing an action of opening and closing means of the back flow preventing device;

FIG. 13 is a perspective view showing an outward appearance of a micro fogging device for forming a vortex when fog is sprayed by the micro fogging device according to a further preferred embodiment of the present invention; and

FIG. 14 is a sectional view showing an action of the micro fogging device of FIG. 13.

### DETAILED DESCRIPTION OF THE INVENTION

Hereinafter, an explanation on micro fogging device and method according to the present invention will be in detail given with reference to the attached drawing.

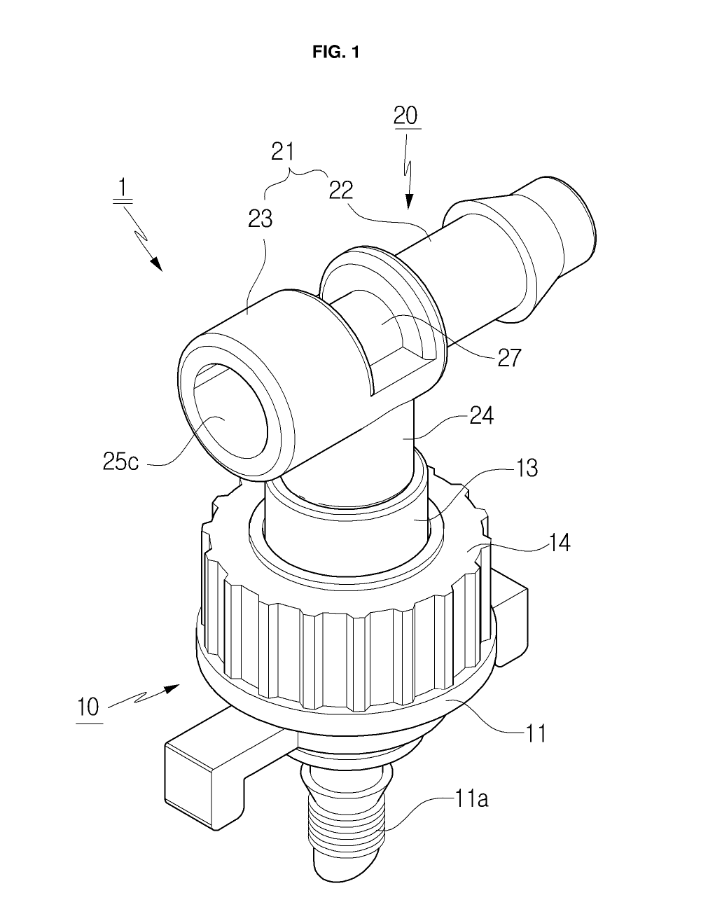

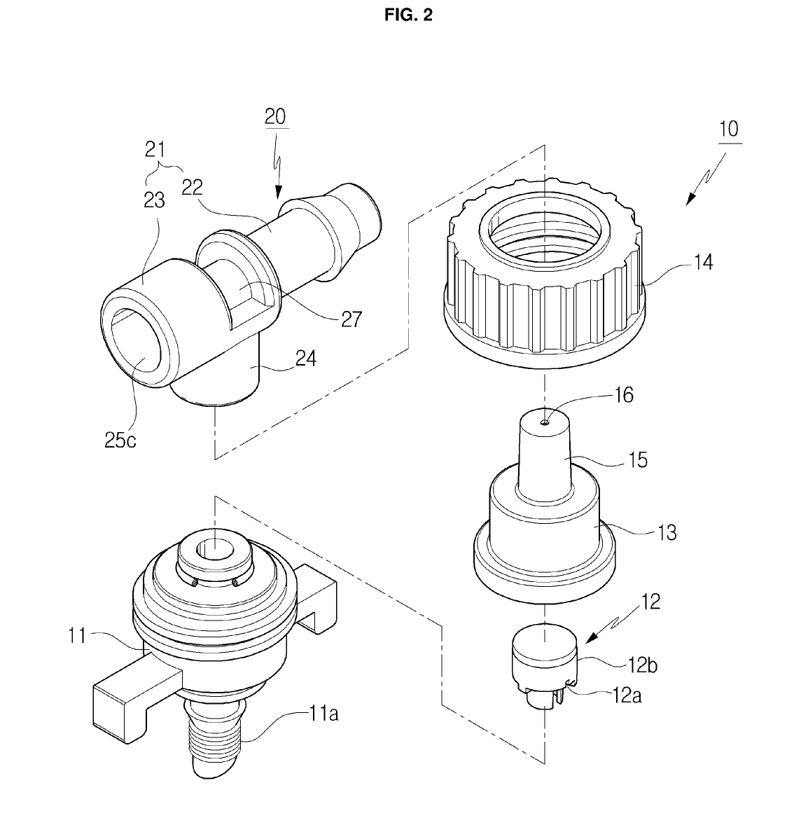

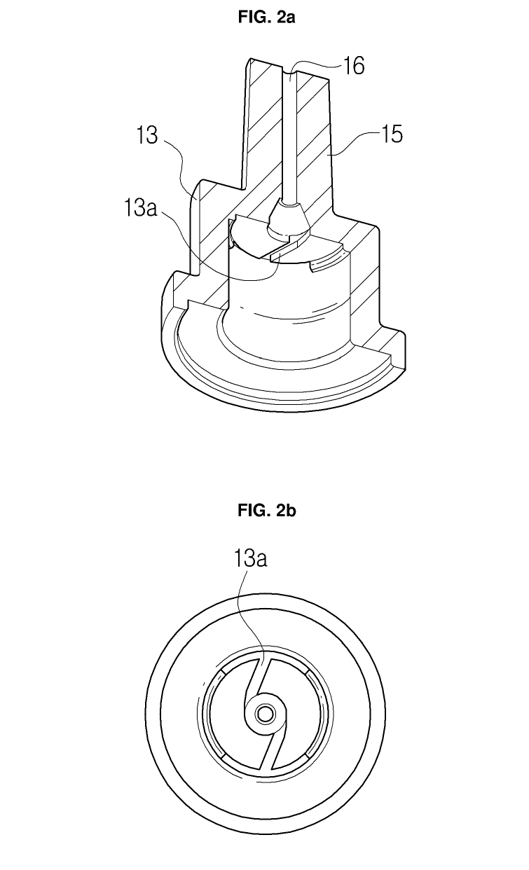

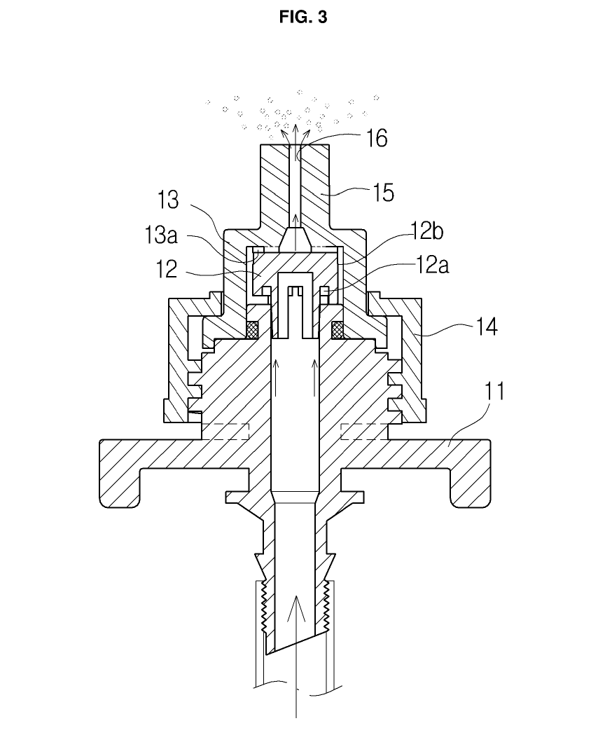

FIG. 1 is a perspective view showing an outward appearance of a micro fogging device according to a preferred embodiment of the present invention, FIG. 2 is an exploded perspective view of the micro fogging device according to the preferred embodiment of the present invention, FIG. 2a is a bottom prospective and sectional view of the nozzle body of the micro fogging device according to the preferred embodiment of the present invention, FIG. 2b is a bottom plan view of the nozzle body of the micro fogging device according to the preferred embodiment of the present invention, and FIG. 3 is a sectional view of a low pressure fog applied to the present invention.

As shown in the drawings, the micro fogging device 1 according to the present invention includes: a low pressure fog 10 for first pulverizing and spraying water (fluid) supplied at low pressure; and a venturi nozzle 20 for second pulverizing the first pulverized water particles supplied from the low pressure fog 10 into fog-like particles using the venturi tube principle.

The low pressure fog 10 according to the present invention serves to first pulverize water supplied, and may be one of various kinds of low pressure fogs on the market.

The low pressure fog illustrated in FIGS. 1 to 3 is a prior application for registration invented and filed by the same inventor as the present invention with Korean Patent Application No. 10-2014-0183526 and is configured to form fog at a low pressure (in the range of 2 to 3 kg/cm²). The low pressure fog 10 includes: a fogging device body 11; a fluid induction member 12 seated on the upper part of the fogging device body 11; a nozzle body 13 for sealing the upper part of the fluid induction member 12; and a contacting nut 14 screw-coupled to the fogging device body 11 in order to press the nozzle body 13 toward the fluid induction member 12. The low pressure fog 10 forms fog by induction of the fluid induction member 12 and the nozzle body 13.

In the present invention, a coupling pipe 15 having a nozzle hole 16 formed therein is formed long in front of the nozzle body 13 of the low pressure fog 10. In this instance, the coupling pipe 15 is tapered in such a way that its diameter becomes gradually smaller toward the end thereof.

The low pressure fog 10 discharges water particles to the nozzle hole 16, which is disposed inside the coupling pipe 15 formed in front of the nozzle body 13, in a fog state (discontinuous state).

In the micro fogging device 1 according to the present invention, the fluid induction member 12 or the nozzle body 13 of the low pressure fog 10 or the venturi nozzle 20 is molded with synthetic resin. Therefore, before molding, a silver nano material or an antimicrobial is put in the raw material.

1 to 2 parts by weight of the silver nano material or antimicrobial is put in 100 parts by weight of a polymer material. Because the technology to mix the silver nano material to the polymer material (HDPE or others) has been widely known, a detailed description will be omitted.

When the fluid induction member 12 or the nozzle body 13 of the low pressure fog 10 or the venturi nozzle 20 is molded, it can prevent inhabitation of germs by the silver nano material and antimicrobial even though water remains inside the fluid induction member 12 or the nozzle body 13 of the low pressure fog 10 or the venturi nozzle 20.

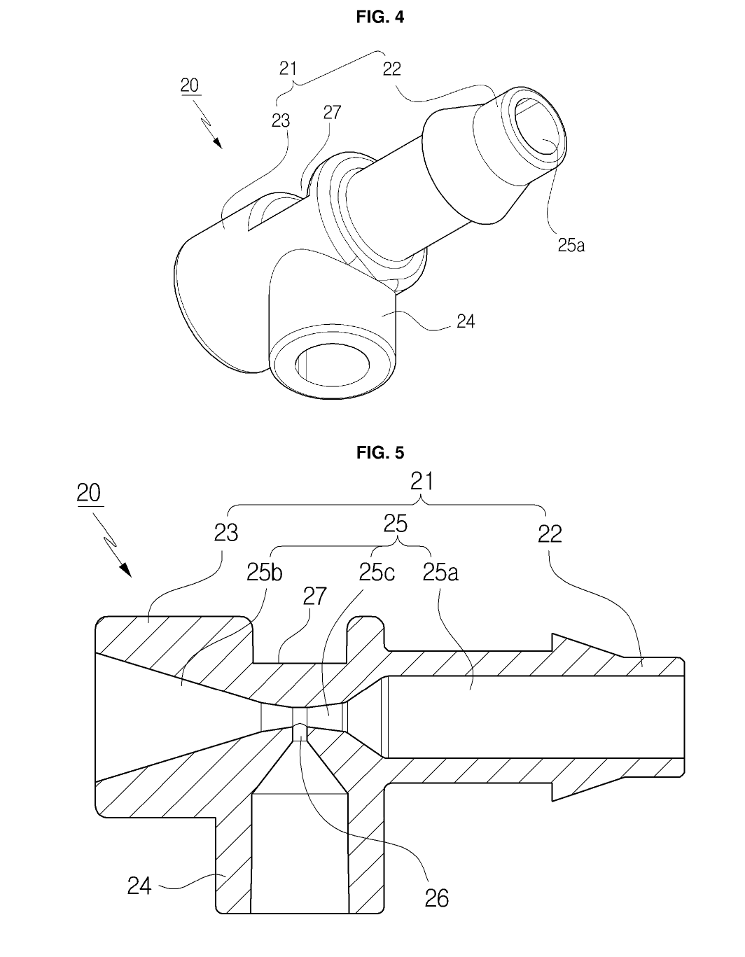

FIG. 4 is an enlarged bottom side perspective view of a venturi nozzle applicable to the present invention, and FIG. 5 is a sectional view of FIG. 4.

The venturi nozzle 20 applied to the present invention includes a body 21 formed by a first coupler 22, to which a compressed air supply pipe 30 for providing compressed air is coupled, and a spray pipe 23 formed in a straight type with the first coupler 22; and a second coupler 24 which is formed at right angles to the first coupler 22 and to which the coupling pipe 15 formed integrally with the nozzle body 13 of the low pressure fog 10 is fit.

An inflow hole 25a is formed in the inside of the first coupler 22 and the spray pipe 23 for allowing inflow of compressed air, an expansion part 25b is formed in the inside of the spray pipe 23, and a throttle ring 25c is formed on the boundary between the inflow hole 25a and the expansion part 25b, so that a venturi tube 25 is formed to reduce pressure of the compressed air supplied through the inflow hole 25a and increase conveying speed. A flow path 26 communicating with the coupling pipe 15 of the low pressure fog 10 coupled to the second coupler 24 is formed in the throttle ring 25c.

Moreover, a joining recess 27 is concavely formed between the first coupler 22 and the spray pipe 23. Joining means, such as a PP band, is inserted and fixed into the joining recess 27 when there is a need to fix the joining means in the state where the venturi nozzle 20 is connected to the low pressure fog 10. Therefore, the joining recess 27 can solve the problem that the joining means is exposed to the outside.

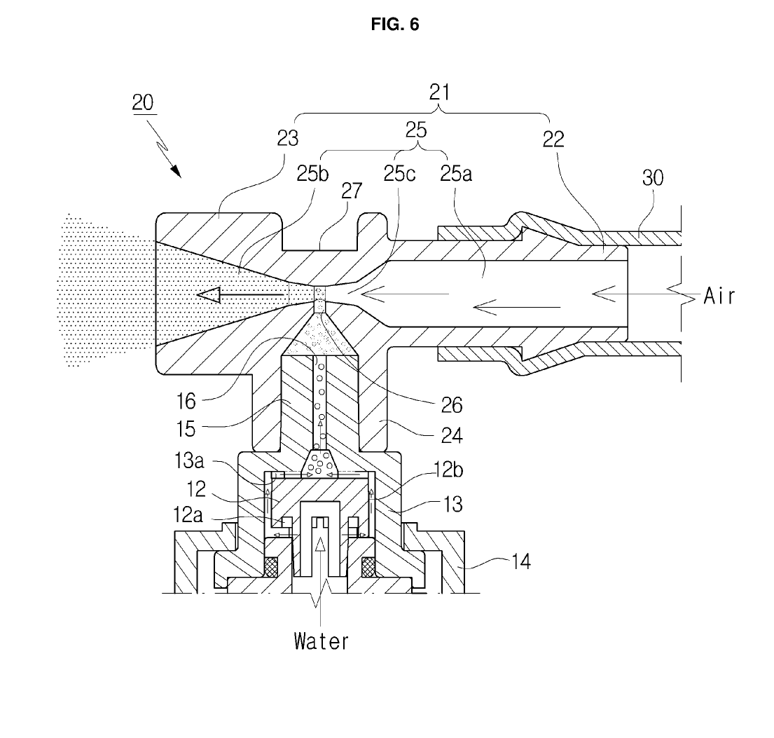

FIG. 6 is a sectional view showing an operational state of the micro fog provided by the present invention.

A micro fogging method using the micro fogging device 1 according to the present invention includes: a first step of first pulverizing water to form water particles of a sprayed state in the low pressure fog 10; and a second step of second pulverizing the first pulverized water particles using the venturi nozzle 20 to form mist-like micro fog.

When water is supplied by the low pressure fog 10, the water is first pulverized while passing the fluid induction member 12 seated on the upper part of the fogging device body 11 and the nozzle body 13, which seals the upper part of the fluid induction member 12, and then, the water particles are discharged out through the coupling pipe 15 formed integrally at the front of the nozzle body 13.

In other words, the water particles are supplied to vortex flow paths 13a of the nozzle body 13 through the flow path 26 formed in the fluid induction member 12. The vortex flow paths 13a are symmetric to each other and round portions of the ‘6’-shaped vortex flow path 13a and the ‘9’-shaped vortex flow path 13a are overlapped when they are viewed from the bottom. Therefore, the fluid supplied through the flow path 12a formed in the fluid induction member 12 flows in from both directions through the vortex flow paths 13a sealably supplied between a contact protrusion 12b and a fitting hole 17 in a state where the contact protrusion 12 gets in close contact with the upper face of the fitting hole 17, so that the fluids flowing from the both directions collide against each other, and are pulverized and sprayed while passing the nozzle hole 16 (First step).

The water particles pulverized in the first step are finely pulverized. In the present invention, when the coupling pipe 15 is coupled to the second coupler 24 of the venturi nozzle 20, the first pulverized water particles are pulverized again using compressed air provided from the compressed air supply pipe 30 coupled to the first coupler 22 to form mist-like micro fog.

That is, when compressed air is supplied through the compressed air supply pipe 30 toward the inflow hole 25a of the venturi tube 25, pressure of the compressed air becomes minimized and conveying speed becomes maximized while the compressed air passes the throttle ring 25c. In this instance, vibration is momentarily generated in the flow path 26 which is connected with the throttle ring 25c of the venturi tube 25 and communicated with the coupling pipe 15 formed on the nozzle body 13 of the low pressure fog 10. So, the water particles discontinuously sprayed through the coupling pipe 15 are suddenly soaked into the throttle ring 25c, and then, is pulverized again while being discharged to the expansion part 25b inside the spray pipe 23 so as to form fog (Second step).

Therefore, because the low pressure fog 10 and the venturi tube 25 of the present invention are made with a plastic material, the micro fogging device according to the present invention can be manufactured and spread at low prices, minimize water consumption and provide the best fogging capability because providing micro fog that cannot be supplied by the conventional fogging devices.

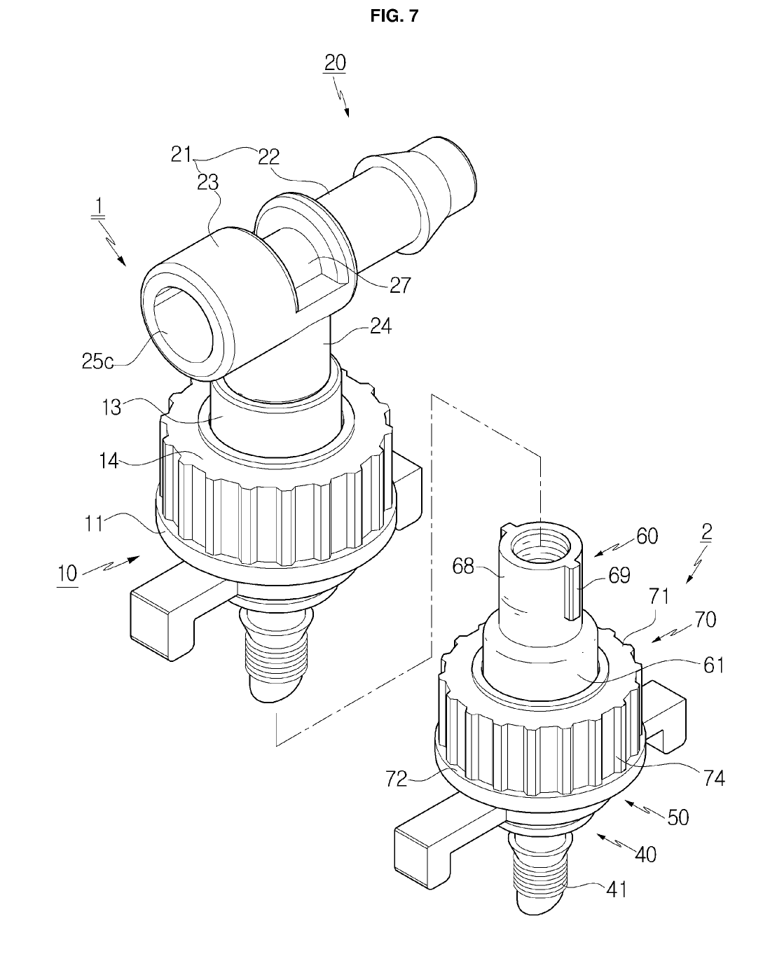

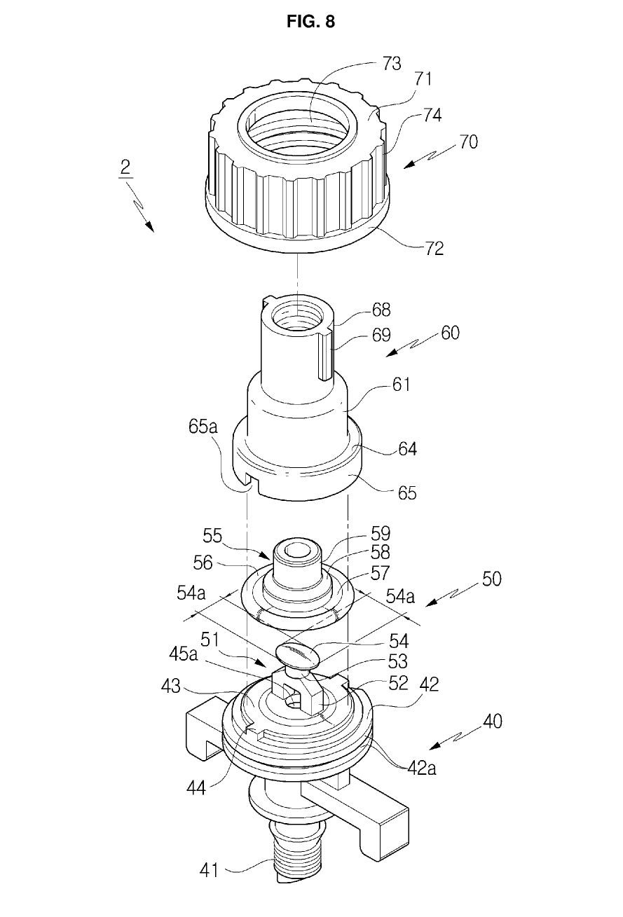

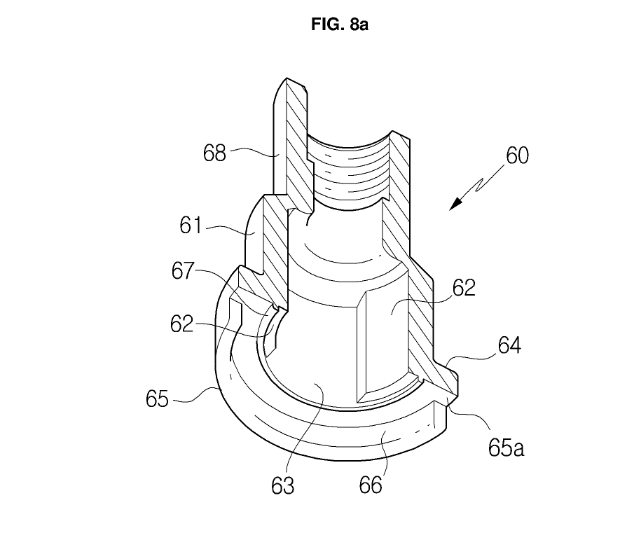

FIG. 7 is a perspective view showing an outward appearance of a micro fogging device for preventing a back flow of compressed air according to another preferred embodiment of the present invention, FIG. 8 is an exploded perspective view showing a micro fogging device of FIG. 7, and FIG. 8a is a bottom prospective and sectional view of the discharge housing of the micro fogging device according to another embodiment of the present invention.

In the meantime, the micro fogging device 1 according to the present invention further includes a back flow preventing device 2 which is connected between the micro fogging device 1 and a fluid pipe (H) for preventing a back flow of the compressed air into a fluid supply fastener 11a in order to prevent stoppage of the fluid pipe (H) by pneumatic pressure.

Such a back flow preventing device 2 includes a main body 40, opening and closing means 50, a discharge housing 60 and a locking nut 70.

The main body 40 includes: a hose connection tube 41 formed at a lower part thereof; a coupling body 42 which is formed on the outer peripheral surface of an upper side and has a screw thread 42a; a seating plate 43 upwardly protruding from an upper end of the coupling body 42 to be inwardly dented at a predetermined interval; at least one rotation preventing unit 44 upwardly protruding from the upper end edge of the coupling body 42 to come into contact with the outer peripheral surface of the seating plate 43; and a flow path hole 45 formed in the middle of the upper/lower part to be hollow.

The opening and closing means 50 includes: an opening and closing member 51 formed on the upper end surface of the seating plate 43 of the main body 43a; and an opening and closing tube 55 connected to the opening and closing member to open and close the flow path only in one axial direction to prevent a back flow of the fluid.

The opening and closing member 51 is a member to support the opening and closing tube 55. Opening and closing support rods 52 upwardly protrude at both sides of an upper end flow path hole 45a of the seating plate 43 to be on the horizon with the rotation preventing unit 44. A connection rod 53 of a predetermined length extends integrally with the upper side of the opening and closing support rods 52, and an opening and closing supporter 54 is formed integrally with the upper end of the connection rod 53.

The opening and closing supporter 54 includes a major axis part 54a and a minor axis part 54b whose diameters are different from each other. The diameter of the major axis part 54a is relatively wider than the minor axis part 54b, and the major axis part 54a of the opening and closing supporter 54 is formed to be in the same axial direction as the rotation preventing unit 44 of the main body 40.

The opening and closing tube 55 includes: a ground plate 57 having a ground ring 56 formed on the rim thereof so that the seating plate 43 is seated thereon; a support tube 58 which upwardly protrudes from the upper end of the ground plate 57 and to which the opening and closing support rods 52 are forcedly fit; and an opening and closing pipe 59 which upwardly extends from the support tube 58 and forcedly gets in contact with the outer peripheral surface of the opening and supporter 54 in order to open and close the flow path only in one axial direction according to discharge pressure of the fluid.

Preferably, such an opening and closing tube 55 is made with rubber or silicon with an elastic restoring force.

Furthermore, when the opening and closing pipe 59 of the opening and closing tube 55 comes into contact with the opening and closing supporter 54 having the major axis part 54a and the minor axis part 54b, tension which pulls the opening and closing pipe 59 in the direction of the major axis part 54a is generated at the major axis part 54a so as to form a stronger watertight structure.

The discharge housing 60 includes: a body 61 which is perforated to surround the outside of the opening and closing tube 55; contact protrusions 62 inwardly protruding from both sides of the inner peripheral surface of the body 61 to restrain expansion by getting in contact with the opening and closing pipe 59 abutting on the major axis part 54a of the opening and closing supporter 51; and an extended hole 63 which is inwardly dented from the inner peripheral surface of the body 61 intersecting with the contact protrusions 62 in order to make expansion easy in the outer peripheral surface direction by securing an expansion space 63a around the opening and closing pipe 59 abutting on the minor axis part 54b of the opening and closing supporter 54.

Additionally, the discharge housing 60 further includes: a stepped jaw part 64 which has a diameter larger than that of the body 61 and is formed beneath the body 61 to be connected to the upper end of the coupling body 42; a pressing rim 65 downwardly protruding from the rim of the lower end portion of the stepped jaw part 64 and having a rotation preventing groove 65a to which the rotation preventing unit 44 is inserted while the seating plate 43 of the main body 40 is forcedly fit; and a pressing groove 66 and a pressing protrusion 67 which are formed on the inner face of the pressing rim 65 so that the ground ring 56 of the opening and closing tube 55 is inserted tightly.

In addition, the discharge housing 60 further includes: a discharge pipe 68 which upwardly protrudes from the upper part of the body 61 and has a diameter smaller than that of the body 61 to discharge the fluid; and at least one separation preventing unit 69 which protrudes from the outer peripheral surface of the discharge pipe 68 to prevent separation when a hose is fixed.

The locking nut 70 is to closely fix the discharge housing 60 to the main body 40, and includes: a retaining ring 71 for pressing and fixing the discharge housing 60 to the coupling body 42 of the main body 40 when the stepped jaw part 64 is caught to the retaining ring 71 in a state where the discharge housing 60 penetrates into the center thereof; a locking rim 72 downwardly protruding from the rim of the retaining ring 71; a screw part 73 screw-coupled to the screw thread 42a of the coupling body 42 in the inner peripheral surface of the locking rim 72; and a non-slip protrusion 74 formed on the outer peripheral surface of the locking rim 72 in order to allow a user to easily lock and release with the hand.

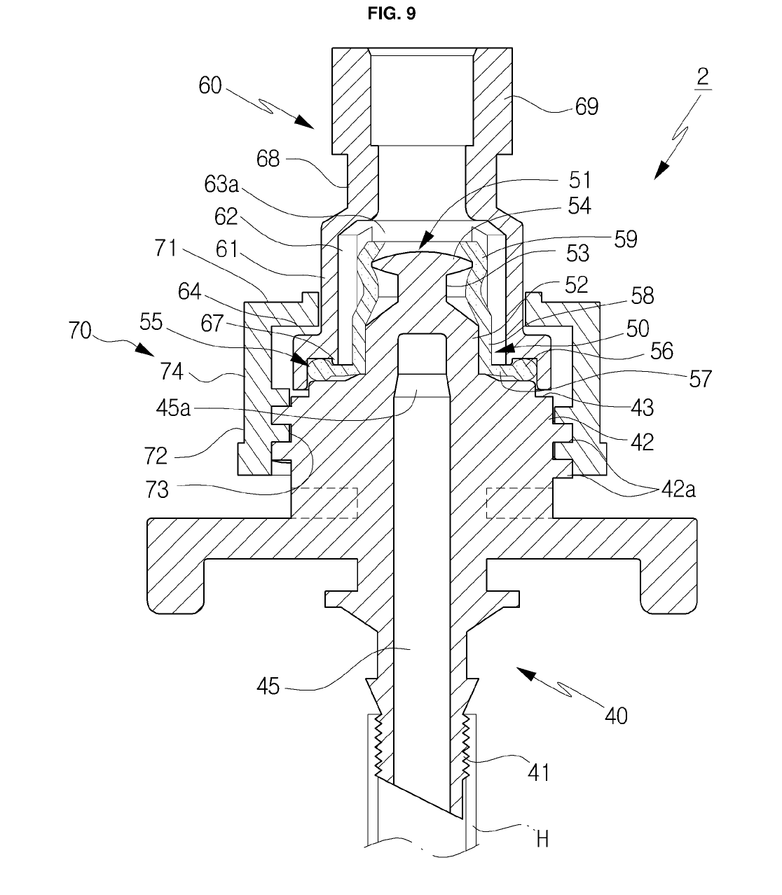

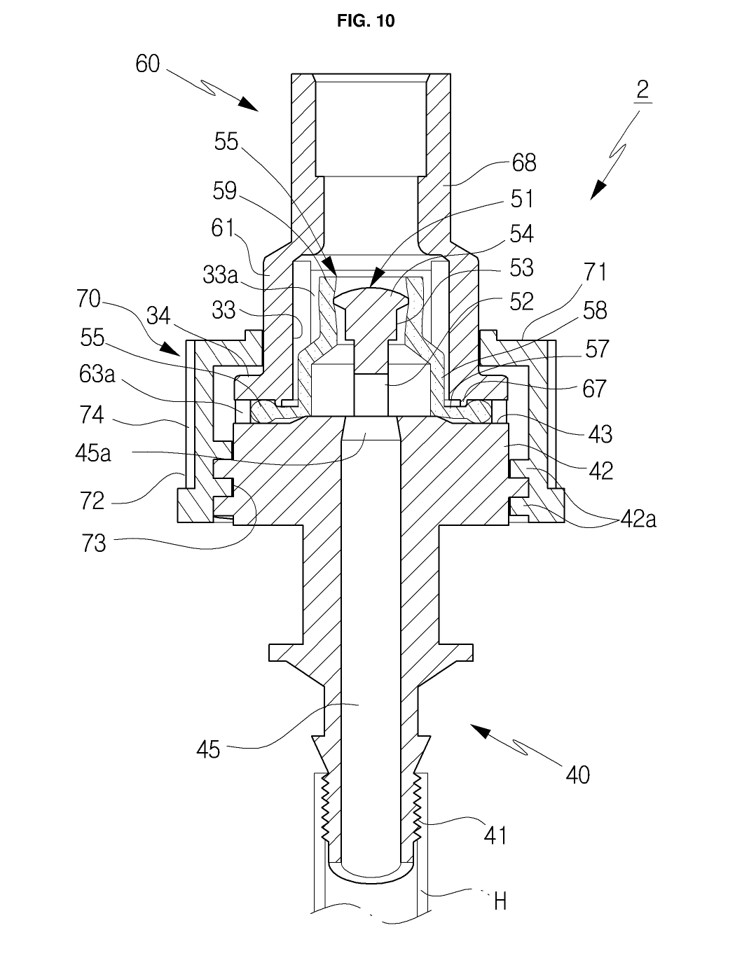

As shown in FIGS. 9 and 10, in the back flow preventing device 2, the opening and closing means 50 is formed when the opening and closing tube 55 is forcedly fit to the opening and closing member 51 formed integrally with the seating plate 43 of the main body 40. After that, the discharge housing 60 is covered on the outer face of the opening and closing tube 55 to be coupled with the main body 40, and then, the rotation preventing unit 44 of the main body 40 and the rotation preventing groove 65a of the discharge housing 60 are coupled to each other. The discharge housing penetrates into the locking nut 70 so that the stepped jaw part 64 of the discharge housing 60 presses the retaining ring 71 of the locking nut 70, and then, the locking nut 70 is screw-coupled to the coupling body 42 through a simple assembly.

In this instance, the round ring 56 of the opening and closing tube 55 is pressed in a state where it is inserted between the pressing groove 66 and the pressing protrusion 67 inside the pressing rim 65 of the discharge housing 60 in order to form a watertight state.

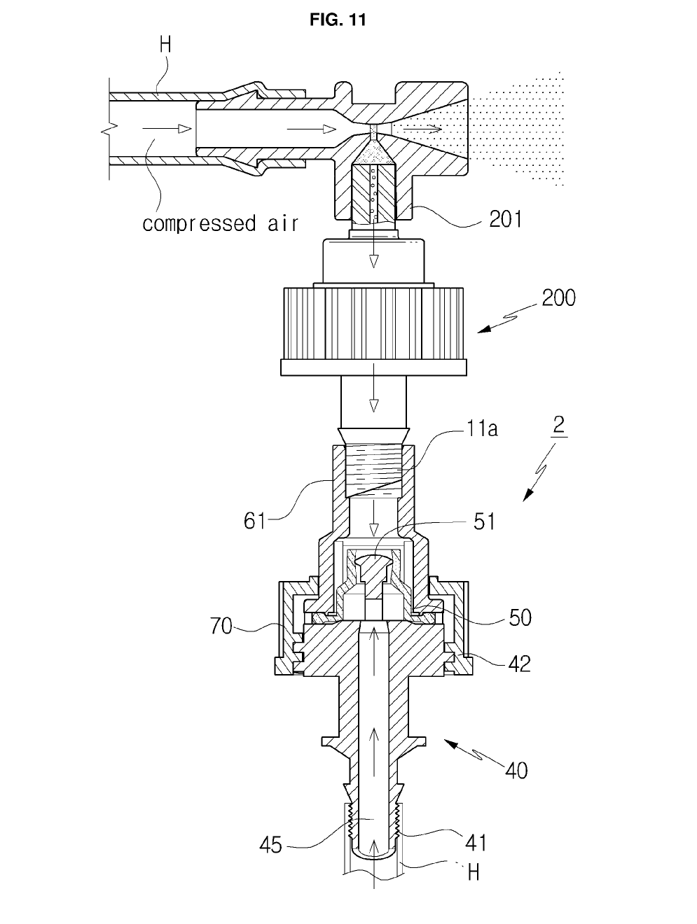

Moreover, as shown in FIG. 11, when the lower end part of the micro fogging device 1 is coupled to the upper end part of the back flow preventing device 2, they are simply coupled with each other by virtue of the screw thread formed on the fluid supply fastener 11 a of the micro fogging device body 11 and the screw thread formed on the inner peripheral surface of the discharge housing 60. The fluid pipe (H) which is a fluid supply hose is connected to the hose connection tube 41 below the back flow preventing device 2.

Therefore, in a state where there is no flow of fluid, when the compressed air flows backward toward the part where the fluid is supplied, because the opening and closing pipe 59 of the opening and closing tube 55 is covered onto the opening and closing supporter 54 having the major axis part 54a and the minor axis part 54b inside the discharge housing 60 and is contracted in a watertight state, it can effectively prevent a back flow of the compressed air toward the fluid pipe (H).

Furthermore, when the fluid flows, discharge pressure by the fluid is formed in the opening and closing pipe 59 abutting on the opening and closing supporter 54 and expands, so that a fluid is supplied to the micro fogging device 1 while a gap is formed between the minor axis part 54b of the opening and closing supporter 54 and the opening and closing pipe 59.

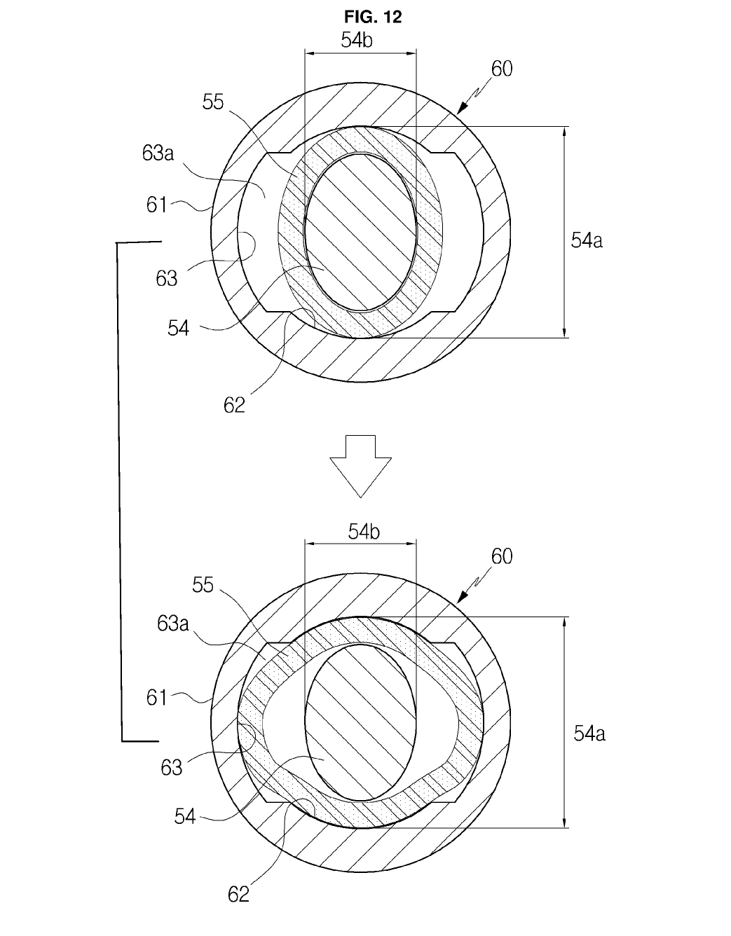

That is, in the state where there is no flow of the fluid, as shown in FIG. 12, the opening and closing pipe 59 comes into close contact with the opening and closing supporter 54 to form tension that the major axis part 54a pulls the opening and closing pipe 59. Accordingly, the micro fogging device according to the present invention can effectively prevent the back flow of the compressed air because contact force between the opening and closing supporter 54 and the opening and closing pipe 59 becomes stronger.

On the contrary, in the state where there is a flow of the fluid, because the major axis part 54a of the opening and closing supporter 54 presses in the state where the contact protrusion 62 of the discharge housing 3 comes into contact with the major axis part 54a, even though there is discharge pressure, it can prevent expansion. However, because the minor axis part 54b is located in the extended hole 63 of the discharge housing 3 to secure the expansion space 63a, the opening and closing pipe 59 abutting on the minor axis part 54b is expanded by the discharge pressure and forms a fluid path while being opened at the same time, so that the fluid can be smoothly supplied to the micro fogging device 1.

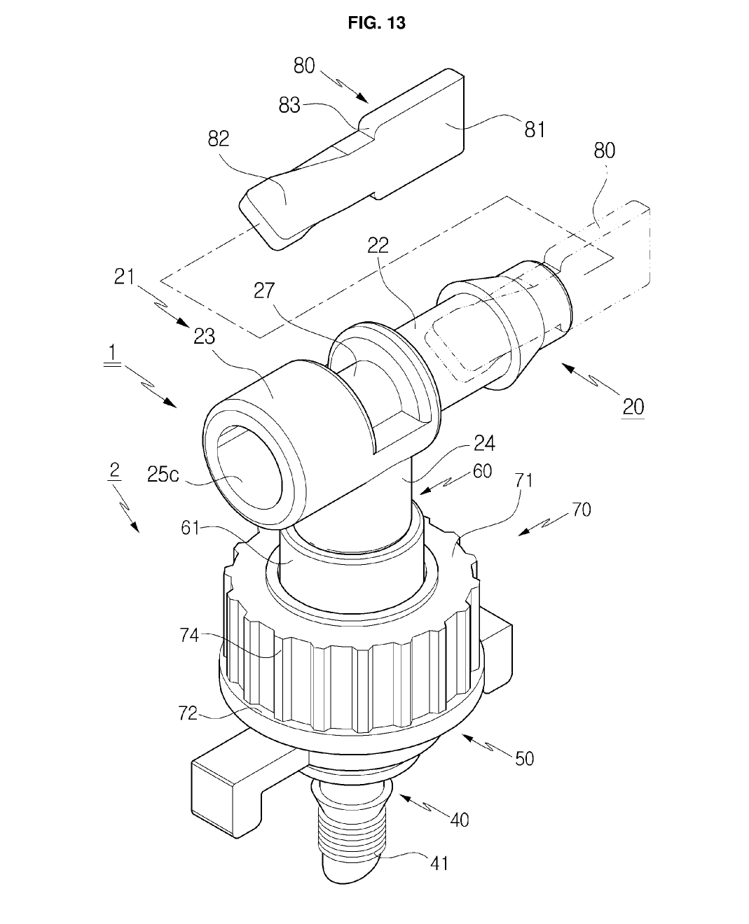

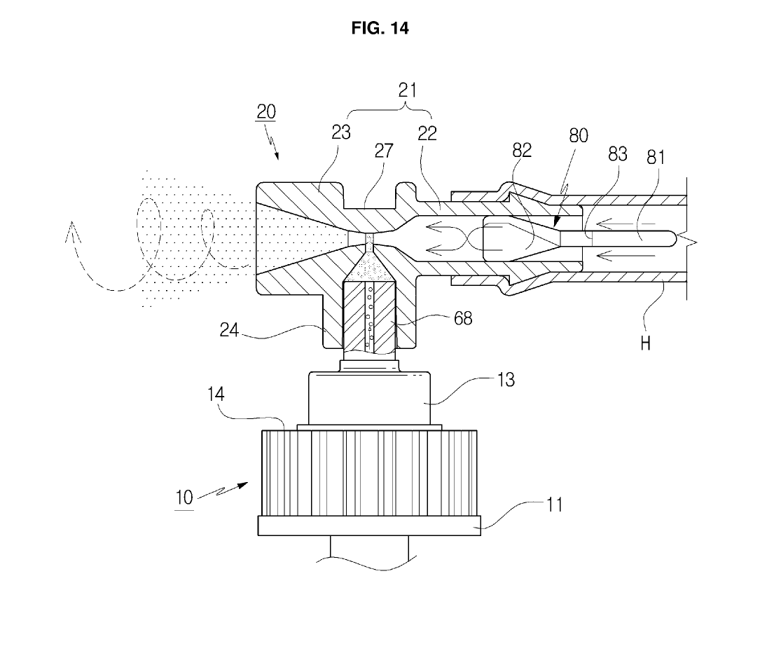

FIG. 13 is a perspective view showing an outward appearance of a micro fogging device for forming a vortex when fog is sprayed by the micro fogging device according to a further preferred embodiment of the present invention, and FIG. 14 is a sectional view showing an action of the micro fogging device of FIG. 13.

The micro fogging device 1 according to the present invention may further include a vortex pin 80 inserted into the inflow hole 25a through which the compressed air of the venturi tube 25 flows to form a vortex when fog is sprayed by the venturi nozzle 20 so as to provide uniform spraying toward the center when fog is sprayed by centrifugal force by the vortex.

The vortex pin 80 includes: a vertical division piece 81; a vortex piece 82 protruding from one end of the vertical division piece 81 in a twisted form; and a retaining jaw 83 formed by the vortex piece 82 which has a diameter smaller than that of the vertical division piece 82.

When the vortex pin 80 is inserted into the inflow hole 25a of the venturi nozzle, the vertical division piece 81 is located at the outside of the inflow hole by the retaining jaw and couples the compressed air supply pipe 30 to the first coupler 22.

Therefore, when compressed air is flown from the compressed air supply pipe 30, the compressed air is divided by the vertical division piece 81 and moves along the twisted form of the vortex piece 82 to form a vortex. After that, the compressed air passes through the venturi tube 25, so that the micro fogging device according to the present invention can uniformly spray fog by centrifugal force formed by the vortex when fog is sprayed from the spray pipe 23.

While the present invention has been described with reference to the particular illustrative embodiments, it is not to be restricted by the embodiments but only by the appended claims. It will be understood by those of ordinary skill in the art that various changes in form and details may be made therein without departing from the spirit and scope of the present invention, and the technical scope of the present invention will be defined by the following claims and equivalences.

What is claimed is:

1. A micro fogging device comprising:
a low pressure fog for forming fog; and
a venturi nozzle for finely pulverizing water particles discontinuously supplied from the low pressure fog, the venturi nozzle including a body, a venturi tube having an inflow hole through which compressed air flows in and an expansion part connected with the inflow hole by a throttle ring inside a spray pipe, a first coupler and spray pipe formed on the body on the same axial line in a straight form so that the venturi tube is formed, a second coupler formed at right angles to the first coupler, and a flow path communicating with a coupling pipe of the low pressure fog to be connected with the throttle ring,
wherein the low pressure fog and the venturi nozzle are coupled in such a way that the coupling pipe protruding from a nozzle body of the low pressure fog is forcedly fit to the second coupler of the venturi nozzle.

2. The micro fogging device according to claim 1, wherein at least one of a fluid induction member or the nozzle body of the low pressure fog or the venture nozzle is molded with synthetic resin mixed a silver nano material or an antimicrobial to eradicate germs.

3. A micro fogging method comprising:
a first step of first pulverizing water to form water particles through a low pressure fog; and
a second step of second pulverizing the first pulverized water particles in a venturi nozzle by inducing the first pulverized water particles discontinuously provided from the low pressure fog to the venturi nozzle to which the venturi principle is applied so as to obtain micro water particles pulverized by means of air fast flow rate and air expansion.

4. A micro fogging device comprising a back flow preventing device comprising;
a hollow main body including a hose connection tube which is formed at a lower part thereof, a coupling body which is formed on the outer peripheral surface of an upper side and has a screw thread, a seating plate upwardly protruding from an upper end of the coupling body, at least one rotation preventing unit upwardly protruding from the upper end edge of the coupling body, and a flow path hole formed in the middle thereof;
an opening and closing means which is formed at the upper end of the coupling body of the main body to open and close the flow path;
a discharge housing covered on the outside of the opening and closing means, the discharge housing including contact protrusions inwardly protruding from both sides of the perforated inner peripheral surface, a body formed on the inner peripheral surface intersecting with the contact protrusion and having an extended hole, a stepped jaw part formed beneath the body to be connected to the upper end of the coupling body of the main body, a pressing rim downwardly protruding from the rim of the lower end portion of the stepped jaw part and having one or more rotation preventing grooves to which the rotation preventing unit is inserted while the seating plate of the main body is forcedly fit; a pressing groove and a pressing protrusion which are formed on the inner face of the pressing rim so that the ground ring of the opening and closing tube is inserted tightly; and a discharge pipe upwardly protruding from the upper part of the body and connected with the lower end part of the micro fogging device; and
a locking nut including a retaining ring for pressing and fixing the discharge housing to the coupling body of the main body, a locking rim downwardly protruding from the rim of the retaining ring, and a screw part screw-coupled to the screw thread of the coupling body in the inner peripheral surface of the locking rim.

5. The micro fogging device according to claim 4, wherein the opening and closing means comprises:
an opening and closing member formed on the upper end surface of the seating plate of the main body; and
an opening and closing tube connected to the opening and closing member to open and close the flow path only in one axial direction to prevent a back flow of the fluid.

6. The micro fogging device according to claim 4, wherein the opening closing means further comprises: opening and closing support rods upwardly protrude at both sides of an upper end flow of the seating plate of the main body; a connection rod extending integrally with the upper side of the opening and closing support rods; and an opening and closing supporter formed on the upper end of the connection rod,
wherein the opening and closing supporter has a major axis part and a minor axis part whose diameters are different from each other and the diameter of the major axis part is relatively wider than the minor axis part,
wherein the opening and closing tube includes: a ground plate having a ground ring formed on the rim thereof; a support tube which upwardly protrudes from the upper end of the ground plate and to which the opening and closing support rods are forcedly fit; and an opening and closing pipe which upwardly extends from the support tube and forcedly gets in contact with the outer peripheral surface of the opening and supporter,
wherein tension for pulling the opening and closing pipe in the direction of the major axis part is generated in the major axis part when the opening and closing pipe of the opening and closing tube comes into contact with the opening and closing supporter so as to form a strong watertight structure, and
wherein the flow path is opened and closed just in one axial direction because the opening and closing pipe at the major axis part is prevented in contraction by the contact protrusion but the opening and closing pipe at the minor axis part is free in contraction inside the extended hole when discharge pressure is generated by supply of a fluid.

7. The micro fogging device according to claim 1, further comprising:
a vortex pin which is inserted into the inflow hole of the venturi nozzle to form a vortex to the compressed air flown in so that the compressed air passes the venturi tube.

8. The micro fogging device according to claim 7, wherein the vortex pin comprises: a vertical division piece; a vortex piece protruding from one end of the vertical division piece in a twisted form; and a retaining jaw formed by the vortex piece which has a diameter smaller than that of the vertical division piece.
